(19) United States
(12) Patent Application Publication
(10) Pub. No.: US 2018/0252021 A1
(43) Pub. Date: Sep. 6, 2018

(54) CORNER CONNECTOR WITH CAPILLARIES

(71) Applicant: SAINT-GOBAIN GLASS FRANCE, Courbevoie (FR)

(72) Inventors: Katrin FRANK, LEONBERG (DE); Karl-Theo ROES, DUESSELDORF (DE); Erol Ertugrul SACU, STOLBERG (DE); Wolfgang BOETTCHER, RIEDERING (DE)

(21) Appl. No.: 15/739,983

(22) PCT Filed: Oct. 13, 2016
(86) PCT No.: PCT/EP2016/074537

§ 371 Date: May 17, 2018

(30) Foreign Application Priority Data
Oct. 13, 2015 (EP) 15189556.2

(51) Int. Cl. E06B 3/667; E06B 3/663; E06B 3/673; E06B 3/677

(52) U.S. Cl. CPC E06B 3/667; E06B 3/66314; E06B 3/6775; E06B 3/67317; E06B 3/66361

(57) ABSTRACT

A corner connector for connecting two hollow-profile strips of an insulating glazing unit is presented. The corner connector includes a first plug-in leg, a second plug-in leg, a corner region, and a capillary tube with a first opening and a second opening. According to one aspect, the corner region connects the second plug-in leg to the first plug-in leg so to form angle between 45° and 180° between the two plug-in legs. According to another aspect, the first plug-in leg, the second plug-in leg, and the corner region are injection molded, and the capillary tube is integrally molded into the corner region. When installed, the capillary tube establishes a connection between the inner interpane space and corresponding surroundings of the insulating glazing unit.

The invention relates to a corner connector for connecting two hollow-profile strips, an insulating glazing unit, a method for production thereof, and use thereof.

Insulating glazing units usually contain at least two panes made of glass or polymeric materials. The panes are separated from one another via a gas or vacuum space defined by the spacer. The thermal insulation capacity of insulating glass is significantly greater than that of single-pane glass and can be even further increased and improved in triple glazing units or with special coatings. Thus, for example, silver-containing coatings enable reduced transmittance of infrared radiation and thus reduce the cooling of a building in the winter.

In addition to the nature and the structure of the glass, the other components of an insulating glazing unit are also of great significance. The seal and especially the spacer have a great influence on the quality of the insulating glazing unit. Especially the contact points between the spacer and the glass pane are very susceptible to temperature and climate fluctuations. The connection between pane and spacer is produced via an adhesive bond of an organic polymer, for example, polyisobutylene. Besides the direct effects on the physical properties of the adhesive bond, the glass itself in particular has an impact on the adhesive bond. Due to the changes in temperature, for example, from sunlight, the glass expands or contracts again upon cooling. At the same time, this mechanical movement expands or compresses the adhesive bond, which can compensate these movements only to a limited extent through its own elasticity. During the course of the service life of the insulating glazing unit, the mechanical stress described can entail a partial or complete areal detachment of the adhesive bond. This detachment of the adhesive bond can subsequently enable penetration of atmospheric moisture inside the insulating glazing unit. These climatic loads can lead to condensation in the region of the panes and a decrease in the insulating effect.

The interpane spaces are tightly sealed to reduce the atmospheric moisture in the interpane space to a minimum. This is necessary to prevent the development of condensation since moisture could result, in particular, in oxidation of vapor-deposited metal-containing coatings on the panes. Due to the leak-tight design of the interpane space, pressure equalization with the surroundings is, however, not possible. With a change in ambient conditions, such as pressure and temperature, the pressure difference between the surroundings and the inner interpane space results in inward or outward bulging of the glass panes. Among other things, this has as a consequence an increased loading of the edge seal. Moreover, jamming of built-in movable components, such as blinds, can occur due to inward bulging of the panes. To reduce these problems, a connection can be made between an inner interpane space and the surroundings, which enables pressure equalization. The connection must be implemented such that accumulation of water vapor in the interpane space is prevented and, at the same time, penetration of dirt and dust is precluded.

CH 687 937 A5 discloses an insulating glazing unit with a desiccant-filled hollow-profile spacer frame, which has nonperforated sections and sections perforated into the interpane space. A capillary tube that opens into a nonperforated section of the spacer frame is provided for pressure equalization between the pane interior and the external surroundings. The actual capillary tube is arranged in the outer interpane space and is surrounded there by a secondary sealant. An opening of the capillary tube points toward the external surroundings. A disadvantage of this solution is the complicated production of the finished insulating glazing unit. First, a circumferential hollow-profile spacer frame must be produced. An opening of the delicate capillary must then be introduced into the spacer through a bored hole. The capillary itself lies substantially exposed in the outer interpane space until subsequent sealing. The integration of the capillary must, accordingly, be done very carefully and takes a great deal of time.

DE 10 2005 002 285 A1 discloses a complicated insulated glazing pressure equalization system with a capillary and a membrane, provided for use in the interpane space of thermal insulating glazings. The pressure equalization system can also be integrated into an enlarged spacer. Disadvantageous, here again, is the complicated integration of the pressure equalization system that is fastened into bored holes of the spacer via stainless steel clamps.

DE 11 2006 001 274 T5 discloses a tube for neutralizing pressure in a double glazed window. The tube can be provided on one or both ends with a seating for passage of the tube. The seating can be mounted in the region of the frame, but also in the region of the panes. There is no data as to precisely how the seating is mounted. The capillary must be routed through the seating, which is very complicated in the case of lengths of more than half a meter.

The object of the invention is to provide a corner connector for connecting two hollow-profile spacers that enables simple production of an insulating glazing unit with pressure equalization, also to provide an improved insulating glazing unit and an improved method for producing such an insulating glazing unit.

The object of the present invention is accomplished by a corner connector in accordance with independent claim 1. Preferred embodiments are apparent from the subclaims.

An insulating glazing unit according to the invention, a method for producing the insulating glazing unit according to the invention, and use thereof according to the invention are apparent from additional independent claims.

The corner connector according to the invention is suitable for connecting two hollow-profile strips in insulating glazing units. These hollow-profile strips are used as spacers in insulating glazing units. The corner connector comprises at least a first plug-in leg and a second plug-in leg, and, solidly integrated into the corner connector, a capillary tube with a first opening and a second opening. The corner region connects the first plug-in leg to the second plug-in leg. The two plug-in legs form an angle α, where 45°<α≤180°. The two plug-in legs are provided to be plugged, in each case, into a hollow-profile strip and, thus, to connect two hollow-profile strips. The corner region is the region, in which the two plug-in legs are connected. The first plug-in leg, the second plug-in leg, and the corner region are injection molded. Since the plug-in legs and the corner region are injection molded, the capillary is already integrated during the injection molding process and thus fixed particularly solidly and stably in the corner connector. In the context of the invention, “solidly integrated” means that the capillary tube is solidly embedded in the corner connector or molded-in and is not introduced later. The openings of the capillary tube are open and positioned outside the plug-in legs and the corner region. Since the capillary is solidly integrated in the corner connector, drilling into a hollow-profile strip and subsequent introduction of a capillary tube, as described in the prior art, are no longer required. The capillary tube is suitable for establishing a connection, in the finished insulating glazing unit, between the surroundings and the inner interpane space of an insulating glazing unit. The corner connector according to the invention is incorporated during the course of assembly of the spacer frame and, thus, no longer has to be incorporated in a separate step. The corner connector connects two hollow-profile strips that are assembled to form a spacer frame. The two plug-in legs are located in the hollow space of the hollow-profile strips and are completely hidden. The corner connector according to the invention thus provides a simple capability for integrating a capillary tube into an insulating glazing unit with hollow profile spacers.

A spacer frame can be formed by a continuous hollow-profile strip that is bent to form a frame, and whose two ends are connected by a corner connector according to the invention.

A spacer frame can also be assembled from a hollow-profile strip broken into individual sections, wherein two sections of the hollow-profile strip are connected by a corner connector according to the invention and the remaining sections are connected using prior art corner connectors.

In a preferred embodiment of the corner connector according to the invention, the capillary tube is curved or wound at least in a subregion. The capillary tube can, for example, be curved to form a wave shape or wound to form a cylindrical spiral. Through bending or winding of the capillary tube, the length to be installed of the capillary tube is shortened compared to a linear shape of the capillary tube. The length to be installed b of the capillary tube in a curved or spiral shape is shorter than the length to be installed s of the capillary tube in a linear shape. Consequently, a relatively long capillary tube, which would have a length of, for example, 80 cm in a linear form, can be arranged even in relatively small glazing units with edge lengths down to half a meter. Suitable capillaries are typically more than half a meter long in the linear form and, consequently, can be processed only with difficulty. The space-saving arrangement of the capillary additionally has the advantage that the corner angle is easier to store and to assemble. Previously, the use of wound capillaries was possible only with difficulty since prior art capillary tubes were introduced into a spacer only after the fact through a bored hole, which is very difficult for curved capillaries. Since the corner angle according to the invention is injection molded, the capillary can be integrated into the corner angle with no problem even in a curved shape and subsequently easily incorporated into the insulating glazing unit. Preferably, for the relationship of the length to be installed b of the capillary tube in a curved or spiral shape to the length to be installed s of the capillary tube in linear form, the following applies: 0.05≤b/s≤0.55, particularly preferably 0.1≤b/s≤0.35. In this range, particularly good results are obtained.

In another preferred embodiment of the corner connector according to the invention, the capillary tube protrudes from the corner connector on an end face of the first plug-in leg, is arranged inside at least the first plug-in leg, and protrudes from the corner region of the corner connector. The first opening of the capillary tube is situated on the end of the capillary tube protruding from the corner region and the second opening is situated on the end protruding from the first end face. In this arrangement, the capillary tube can, in the finished insulating glazing unit, connect the hollow space of the hollow-profile strip to the atmosphere. Since the hollow-profile strip is usually gas-permeable toward the inner interpane space, pressure equalization between the surroundings and the inner interpane space is enabled in the finished insulating glazing unit. In addition, in this arrangement, the capillary tube is well protected against damage, for example, during transport or assembly of the insulating glazing unit. Since the capillary tube is integrated in the corner region of the corner connector, arranged inside the first plug-in leg, and ends in a section of a hollow-profile strip, it remains hidden to the observer of the finished insulating glass window.

The end face of a plug-in leg is the surface that, on insertion of the corner connector into a hollow-profile strip, faces its hollow space. The end face thus does not rest against an inner side of the hollow-profile strip. After connection of the plug-in legs to a hollow-profile strip, the side faces of the corner region and the corner surface of the corner region are exposed. The side faces of the corner region are the surfaces that, in the finished insulating glazing unit, face toward the outer panes and are arranged parallel to the outer panes of the insulating glazing unit. The side faces of the corner region can also be connected to the outer panes. The corner face is the surface that, in the finished insulating glazing unit, faces the surroundings or at least partially makes contact with the secondary sealant.

In a preferred embodiment of the corner connector according to the invention, the first insertion angle and the second insertion angle form a right angle. This shape is particularly stable and suitable for producing conventional rectangular insulating glass windows.

In another preferred embodiment of the corner connector according to the invention, the first opening of the capillary tube open on both ends is reversibly closed on the end protruding from the corner region, for example, by a rubber cap. The closure serves to protect the first opening against the penetration of dirt or of secondary sealant that is used during the sealing of the insulating glazing unit.

The capillary tube is preferably made of a metal, particularly preferably of stainless steel, aluminum, or an aluminum-containing alloy. With these materials, the penetration of water vapor into the inner interpane space is particularly effectively avoided, as was demonstrated in tests. Particularly preferably, the capillary tube made of metal is surrounded by a protective sheathing made of a plastic. Thus, the delicate capillary tube is protected against damage during transport and installation. The capillary tube can, in another preferred embodiment, also be made of a plastic. The capillary tube then has a metal-containing coating on the inside.

The capillary tube preferably has an inside diameter of 0.4 mm to 0.8 mm, particularly preferably of 0.5 mm to 0.7 mm. The wall thickness of the capillary tube is preferably 0.1 mm to 0.3 mm, particularly preferably 0.2 mm. The length of the capillary tube depends on the dimensions of the insulating glazing unit. It should, in a straightened form, have a minimum length of approx. 60 cm such that the pressure equalization can be realized without water vapor penetrating into the inner interpane space.

The corner connector is preferably implemented rigid. This means that after the production of the corner connector with an integrated capillary, it is no longer bendable in the corner region. The angle α can then no longer be changed substantially, in other words, can be changed by at most 5°, preferably by at most 1°. This design improves the stability of the corner connector and prevents damage of the capillary tube im corner region.

The plug-in legs and the corner region are preferably made of a polymer and particularly preferably contain polyethylene (PE), polycarbonate (PC), polypropylene (PP), polystyrene, polybutadiene, polynitriles, polyesters, polyurethanes, polymethylmethacrylates, polyacrylates, polyamides, polyethylene terephthalate (PET), polybutylene terephthalate (PBT), preferably acrylonitrile butadiene styrene (ABS), acrylonitrile styrene acrylester (ASA), acrylonitrile butadiene styrene/polycarbonate (ABS/PC), styrene acrylonitrile (SAN), PET/PC, PBT/PC, and/or copolymers or mixtures thereof.

In a possible embodiment, the plug-in legs and the corner region are fiber-reinforced. The corner connector preferably has a fiber content of 5% to 60%, particularly preferably of 20% to 50%. The fiber content in the corner connector according to the invention improves strength and stability. Through the selection of the fiber content, the coefficient of thermal expansion of the corner connector can be varied and adapted to the hollow-profile spacer. Preferably, natural fibers or glass fibers, particularly preferably glass fibers, are used for reinforcing the corner connector.

In an alternative embodiment, the corner connector can also be made of metal.

In a preferred embodiment of the connector according to the invention, at least the outer face of the corner region is provided with a water-vapor-tight barrier. This barrier is preferably a metal layer that is applied directly on the outer face of the corner region. This metallization contains aluminum, aluminum oxides, and/or silicon oxides and is preferably applied via a PVD method (physical vapor deposition). The coating containing aluminum, aluminum oxides, and/or silicon oxides delivers particularly good results in terms of leak-tightness. Alternatively, a film coated with metal can also be used. In particular, in the case of connectors made of polymeric materials that have high permeability to water vapor, such an additional barrier is advantageous for improving the leak-tightness of the edge seal.

A method for producing a corner connector according to the invention first includes providing a capillary that is already bent into the desired shape. Next, the capillary is inserted into an injection mold in which the corner connector, comprising the first and second plug-in legs and the corner region, is then molded. After the curing of the material, the finished corner connector can be removed from the injection mold.

The invention further includes an insulating glazing unit having a corner connector with an integrated capillary tube, in particular a corner connector according to the invention. The insulating glazing unit according to the invention comprises at least one first pane, a second pane arranged parallel thereto, and a spacer frame arranged between the first pane and the second pane. The first pane, the second pane, and the spacer frame delimit an inner interpane space. The spacer frame comprises at least one hollow-profile strip and a corner connector, which comprises at least one first plug-in leg, a second plug-in leg, a corner region, and a capillary tube integrated at least in the corner region. The first plug-in leg is connected to the second plug-in leg in the corner region. The first plug-in leg, the second plug-in leg, and the corner region are injection molded. The first plug-in leg and the second plug-in leg are in each case plugged into one end of the hollow-profile strip. Thus, the corner connector connects the hollow-profile strip to form a complete spacer frame. The capillary tube integrated in the corner connector is arranged such that it establishes a connection between the inner interpane space and the atmosphere and thus enables pressure equalization. In this manner, pressure equalization at the time of changes in ambient conditions is ensured in the insulating glazing unit according to the invention with a capillary tube integrated in the corner connector. Since the capillary tube is integrated according to the invention in the corner connector, the insulating glazing unit can be produced particularly simply.

The hollow-profile strip can comprise a plurality of discontinuous sections, which are in each case combined in the corners of the insulating glazing unit to form a complete frame. The sections can be welded together, glued together, or plugged together via connectors. The hollow-profile strip can also be produced continuously and bent in the corners. Preferably, the spacer frame is implemented rectangular. Most insulating glazing units are made in this shape.

The spacer frame is preferably attached between the first pane and the second pane via a primary sealant. Thus, good sealing of the inner interpane space against the external surroundings is obtained. The penetration of moisture and the loss of a gas filling that is possibly present is thus prevented. The primary sealant preferably contains a polyisobutylene. The polyisobutylene can be a cross-linking or a non-cross-linking polyisobutylene.

A known prior art hollow-profile strip can be used as hollow-profile strip regardless of its material composition. Polymeric or metallic hollow-profile strips are mentioned here by way of example.

In a preferred embodiment of the insulating glazing unit according to the invention, the hollow-profile strip comprises at least one first side wall, a second side wall arranged parallel thereto, a glazing interior wall arranged perpendicular to the side walls, and an outer wall. The glazing interior wall connects the side walls to one another. The outer wall is arranged substantially parallel to the interior wall and connects the side walls to one another. The first side wall, the glazing interior wall, the second side wall, and the outer wall enclose a hollow space. The hollow space improves the thermal conductivity of the hollow-profile strip compared to a solid profile strip and can, for example, accommodate a desiccant. The glazing interior wall contains at least one gas-permeable section such that a connection between the hollow space and the interpane space is present. In the permeable section, the exchange of gas and moisture between the inner interpane space and the hollow space is possible. The hollow space contains, at least in the permeable section, a desiccant that absorbs any moisture present in the inner interpane space and thus prevents fogging of the panes. The permeability of the glazing interior wall can be obtained by the use of a porous material and/or by at least one perforation in the glazing interior wall. Preferably, the glazing interior wall contains perforations in the permeable section. The total number of perforations depends on the size of the insulating glazing unit. The perforations connect the hollow space to the inner interpane space, by which means a gas exchange therebetween is possible. The perforations are preferably implemented as slots, particularly preferably as slots with a width of 0.2 mm and a length of 2 mm. The slots ensure an optimum exchange of air without the desiccant being able to penetrate out of the hollow space into the inner interpane space.

The first side wall and the second side wall of the hollow-profile strip are provided for the first pane and the second pane to be attached there. Preferably, the first pane and the second pane are attached to the first side wall or to the second side wall via a primary sealant. The inner interpane space is delimited by the first pane, the second pane, and the glazing interior wall of the hollow-profile strip. The outer wall of the hollow-profile strip and the first and second pane delimit an outer interpane space. The outer interpane space is preferably filled with a secondary sealant. The secondary sealant contributes to the mechanical stability of the insulating glazing unit and absorbs part of the climatic loads that act on the edge seal.

Preferably, the secondary sealant contains polymers or silane-modified polymers, particularly preferably organic polysulfides, silicones, room-temperature vulcanizing (RTV) silicone rubber, peroxide vulcanizing silicone rubber, and/or addition vulcanizing silicone rubber, polyurethanes, and/or butyl rubber. These sealants have a particularly good stabilizing effect.

The hollow space preferably contains a desiccant, preferably silica gels, molecular sieves, CaCl₂, Na₂SO₄, activated carbon, silicates, bentonites, zeolites, and/or mixtures thereof.

In another preferred embodiment of the insulating glazing unit according to the invention, the capillary tube has a first opening, which is open to the atmosphere, and a second opening, which is arranged in the hollow space of the hollow-profile strip. The capillary tube runs at least inside the first plug-in leg and in the corner region. Since the capillary tube opens into the hollow space of the hollow-profile strip and establishes a connection to the atmosphere, pressure equalization between an inner interpane space and the atmosphere can occur. In the permeable section of the glazing interior surface, a connection is made between the hollow space and an inner interpane space. The permeable section is connected to the section of the hollow-profile strip into which the capillary opens, or it is itself a permeable section. Thus, an insulating glazing unit with pressure equalization can be easily produced, by establishing a connection between the hollow space and the atmosphere. Since the capillary tube is integrated into the corner connector, it is optimally protected against bending out of shape during installation and also during the service life of the insulating glazing unit.

In a preferred embodiment of the insulating glazing unit according to the invention, only 40% to 0.5%, preferably 25% to 1%, particularly preferably 15% to 1% of the length s (based on a straightened form) of the capillary tube is arranged outside the spacer frame. The term “outside the spacer frame” means in the outer interpane space and in the surroundings of the insulating glazing unit. In this arrangement, most of the capillary tube is arranged inside the hollow space of the hollow-profile strip. Compared to arrangements in which more than 50% of the length of the capillary tube runs outside the spacer frame, the capillary tube inside the spacer frame is optimally protected against external influences, such as mechanical loading.

Thus, fewer instances of damage to the capillary tube occur during assembly of the insulating glazing unit. The sealing of the insulating glazing unit with a secondary sealant can then be automated since most of the delicate capillary tube is situated inside the hollow-profile strip and thus does not interfere with the filling of the outer interpane space.

In a preferred embodiment of the insulating glazing unit according to the invention, the second opening of the capillary tube is arranged in a section of the hollow-profile strip having an impermeable glazing interior wall, wherein this impermeable section is connected to a permeable section. Thus, the ambient air flowing in through the capillary tube does not arrive directly in the inner interpane space but arrives first in the impermeable section. Preferably, the impermeable section is at least partially filled with a desiccant such that the air flowing in can first be pre-dried before it arrives in the connected gas-permeable section in the inner interpane space. Particularly preferably, the gas flow is interrupted by the spacer frame or the hollow profile sections in the region of the corner connector. This interruption can, for example, be introduced by a corner connector according to the invention, which enables no gas exchange between the connected ends of the hollow-profile strip. Alternatively, a partition or a gas-permeable rubber stopper can be introduced into the hollow profile strip. By means of the interruption of the gas flow, it is ensured that the ambient air flowing in through the capillary tube flows in only one direction and thus always first through the same section, preferably filled with desiccant. Thus, the efficiency of the drying can be further increased.

The length d of the impermeable section, measured along the circumferential spacer frame, is preferably at least 0.2 U, where U is the circumference of the spacer frame along the glazing interior wall. Preferably the following applies: d≥0.3 U, particularly preferably d≥0.5 U. Thus, the drying path of the stream of air is increased in the gas impermeable region, such that the long-term stability, insulating action, and service life of the glazing are further optimized.

Preferably, all sections of the hollow-profile strip are filled with a desiccant such that maximum drying of the inflowing ambient air and of the inner interpane space are ensured.

In an alternative preferred embodiment, at least the section of the hollow-profile strip in which the second opening of the capillary tube is arranged is free of desiccant. Thus, clogging of the capillary tube with desiccant is prevented and damaging of the capillary tube during filling with desiccant is precluded. The filling of approx. 25% of the hollow-profile strip with desiccant is sufficient to ensure dehumidification of the inner interpane space. Preferably, at least 30%, particularly preferably at least 50% of the hollow-profile strip is filled with desiccant in order to increase the drying capacity.

In a preferred embodiment of the insulating glazing unit, the insulating glazing unit includes a corner connector according to the invention, as described above.

The first and second pane of the insulating glazing unit preferably contain glass and/or polymers, preferably flat glass, float glass, quartz glass, borosilicate glass, soda lime glass, polymethylmethacrylate, and/or mixtures thereof. In an alternative embodiment, the first pane and/or the second pane can be implemented as composite glass panes.

The insulating glazing unit can also include more than two panes.

The invention further includes a method for producing an insulating glazing unit according to the invention, wherein, first, a hollow-profile strip is prepared and this is connected to at least one corner connector to form a complete spacer frame. In the case of a discontinuous hollow-profile strip, the individual sections can be connected with prior art corner connectors without an integrated capillary. Next, at least one section of the hollow-profile strip is filled with a desiccant. A first section, into which the capillary tube opens, is not filled with desiccant. Next, the first and second pane are installed on the spacer frame via a primary sealant, creating an inner interpane space and an outer interpane space. In the last step, a secondary sealant is installed in the outer interpane space, and the pane arrangement is pressed. The method according to the invention for producing an insulating glazing unit with pressure equalization is significantly simplified compared to prior art methods for integration of capillary tubes. No separate step is necessary for installation of the capillary tube. Also, no bored holes have to be made, since the installation of the capillary tube is done with the corner connector.

The invention further includes the use of the insulating glazing unit according to the invention as a building interior glazing unit, a building exterior glazing unit, and/or a façade glazing unit.

The invention is explained in detail in the following with reference to figures. The figures are purely schematic representations and not true to scale. They in no way restrict the invention. They depict:

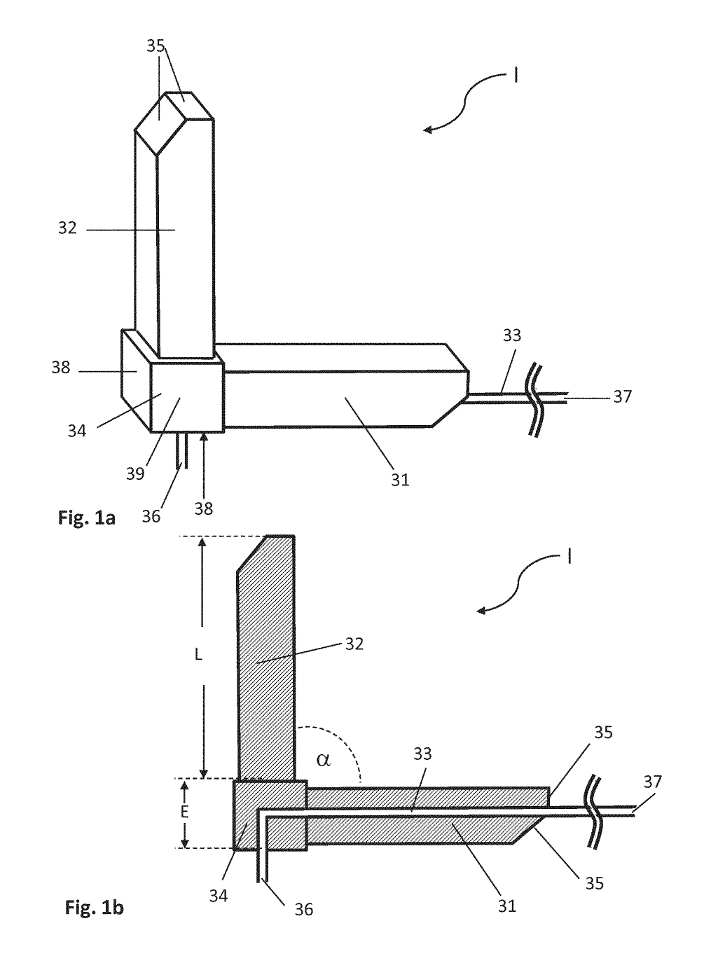

FIG. 1a a schematic, perspective view of an embodiment of the corner connector according to the invention,

FIG. 1b a schematic cross-section of the corner connector according to the invention of FIG. 1a,

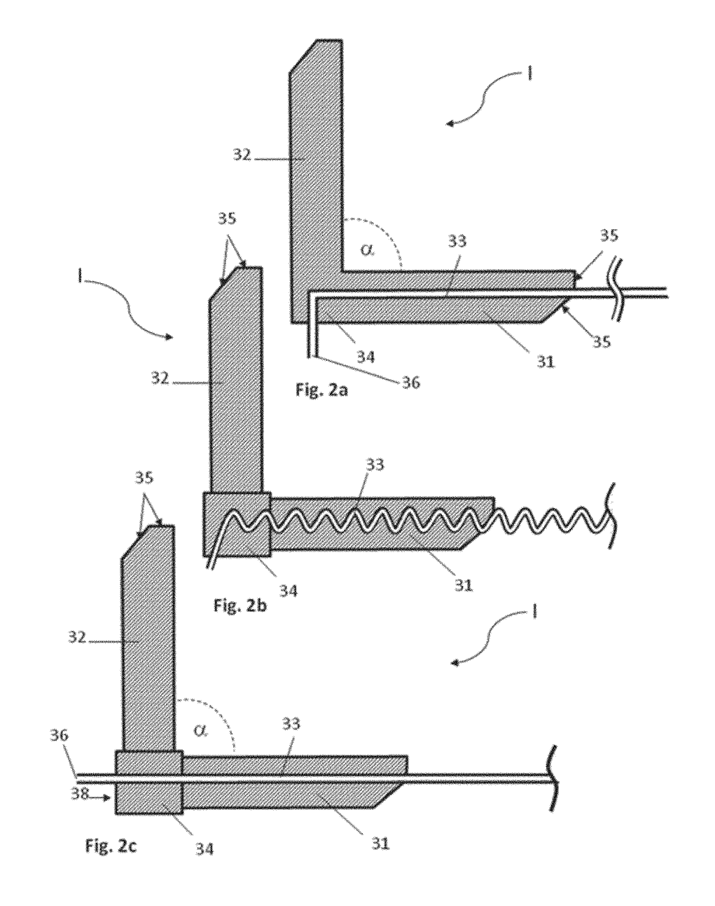

FIGS. 2a, 2b and 2c in each case a schematic cross-section of an embodiment of the corner connector according to the invention,

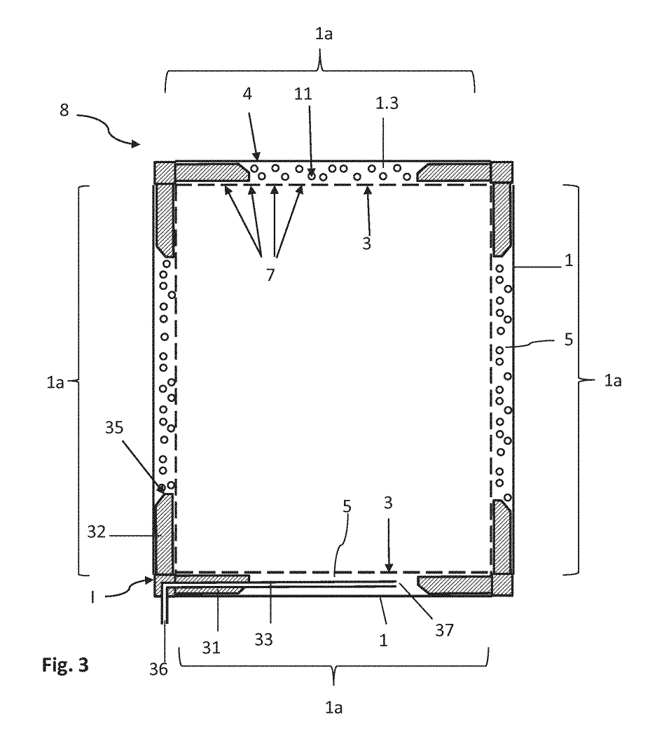

FIG. 3 a cross-section of a spacer frame with a corner connector according to the invention,

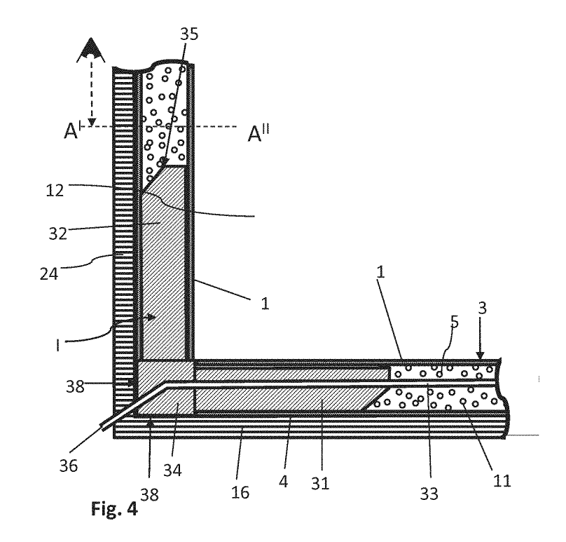

FIG. 4 the corner region of an insulating glazing unit according to the invention in cross-section,

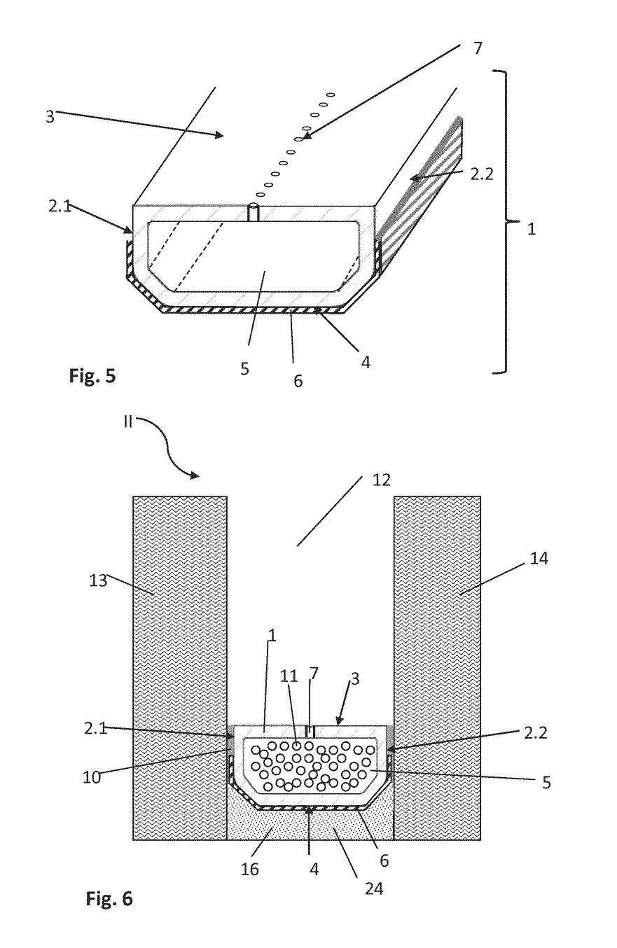

FIG. 5 a perspective cross-section of a hollow-profile strip 1,

FIG. 6 a cross-section of a section of an insulating glazing unit according to the invention,

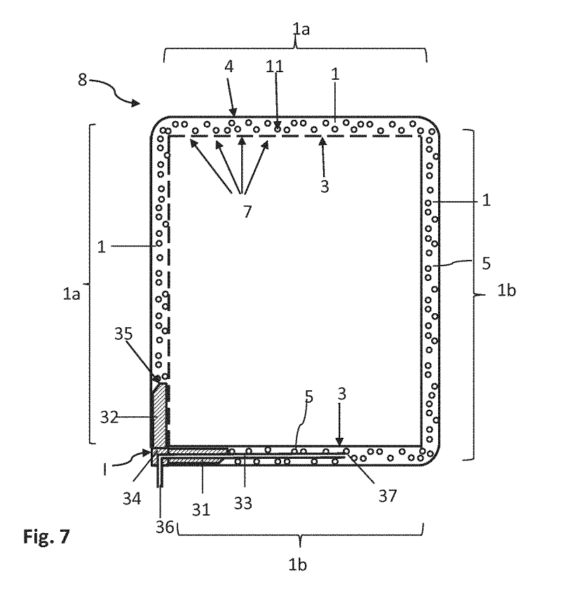

FIG. 7 a cross-section of a spacer frame with a corner connector according to the invention.

FIG. 1a, b depicts a schematic representation of a corner connectors I according to the invention. The representation is greatly simplified. Fins or retaining elements, as they are used according to the prior art, to fix the corner connectors in a hollow-profile strip, are, for example, not shown. These can be added by the person skilled in the art as needed. The corner connector I comprises a first plug-in leg 31 and a second plug-in leg 32, which are connected to one another by the corner region 34. The two plug-in legs 31 and 32 form an angle α (alpha) of 90°. The plug-in legs 31 and 32 and the corner region 34 are produced from a polyamide in one piece in an injection molding process. A capillary tube 33 made of stainless steel is integrated (molded-in) in the first plug-in leg 31 and in the corner region 34. The capillary tube 33 is arranged in the interior of the corner connector 34 and, thus, well protected against external influences. The capillary tube 33 has a first opening 36 and a second opening 37. The capillary tube 33 enters the corner connector on the end face 35 of the first plug-in leg 31, runs along the first plug-in leg 31, is angled in the corner region 34, and exits again in the corner region 34, more precisely in the region of the corner face 38, of the corner connector I. The corner face 38 is the surface, which points toward the surroundings in the finished insulating glazing unit or makes contact at least partially with the secondary sealant 16. The corner face 38 is, in this case divided into two areas. The side faces 39 are, in contrast, the surfaces of the corner region 34, that point toward the outer panes in the finished insulating glazing unit, run parallel to the outer panes of the insulating glazing unit, and are optionally, connected thereto. Consequently, the capillary 33 exits again in the region of the corner face 38, then runs through the secondary sealant of the insulating glazing unit, and opens into the atmosphere (see FIG. 4). The capillary tube 33 has already been integrated during the injection molding process such that it is solidly anchored in the corner connector I. The capillary tube 33 has, for example, a length of 80 cm and an inside diameter of 0.6 mm. The length of the capillary tube is adapted according to the dimensions of the insulating glazing unit. Most of the capillary tube 33 runs outside the first plug-in leg 31. The dimensions of the corner connector depend on the hollow-profile strips 1 used. The length L of a plug-in leg is, in the example, 3.0 cm, and the length E of the corner region is approx. 0.7 cm. The corner region 34 protrudes relative to the plug-in legs 31 and 32 such that a hollow-profile strip 1 that is pushed onto a plug-in leg 31, 32 and rests against the corner region 34 ends flush with the corner region 34. This protruding corner region 34 has, additionally, the advantage that by means of it, a reinforcement of the corner region 34 is achieved, by means of which the capillary tube 33 is optimally protected. The corner region 34 is implemented rigid, in other words, the angle α (alpha) cannot be changed substantially. Thus, the capillary 33 is optimally protected against being bent out of shape in the corner region 34.

FIG. 2a depicts a schematic cross-section of an embodiment of the corner connector I according to the invention. The corner connector depicted differs from the corner connector depicted in FIG. 1a, b in the corner region 34. The corner region 34 does not protrude relative to the plug-in legs 31 and 32 and is thus not as additionally reinforced. This simplifies production of the corner connector I.

FIG. 2b depicts a cross-section of another embodiment of the corner connector I according to the invention. The corner connector I depicted differs from the corner connector depicted in FIG. 1a, bin the shape of the capillary tube 33. The capillary tube 33 is wound in the shape of a spiral. This variant is in particular suitable for smaller insulating glazing units since a capillary tube of the same length can be incorporated using less space.

FIG. 2c depicts a cross-section of another embodiment of the corner connector I according to the invention. The corner connector I depicted differs from the corner connector depicted in FIG. 1a, b through the arrangement of the capillary tube 33 in the corner region 34. The capillary tube 33 is not angled but, instead, runs straight through the first plug-in angle 31 and the corner region 34 and exits again in the region of the corner face 38. This variant is simpler to produce since the capillary tube 33 no longer needs to be bent before the injection molding process.

FIG. 3 depicts a cross-section through a spacer frame 8 having a corner connector I according to the invention. The spacer frame 8 comprises four hollow-profile strips 1. The shorter strips are, in each case, 100 cm long, while the longer strips are, in each case, 200 cm long. The four hollow-profile strips 1 are connected via three prior art corner connectors and one corner connector I according to the invention and form a rectangular spacer frame 8. The corner connector I according to the invention is described in FIG. 1. The first plug-in leg 31 and the second plug-in leg 32 are, in each case, plugged into one of the hollow-profile strips 1. The corner region 34 of the corner connector I is exposed, while the first plug-in leg 31 and the second plug-in leg 32 are, in each case, hidden in the hollow-profile strip 1. The end faces 35 of the plug-in legs 31 and 32 point toward the hollow space 5 and do not rest against an inner side of the hollow-profile strip. The structure of a hollow-profile strip 1 is shown in FIG. 5 by way of example. The hollow-profile strip 1 includes a hollow space 5. The hollow space 5 is filled along three sides of the spacer frame 8 with a desiccant 11, for example, with molecular sieve. The hollow space 5 is, in the finished insulating glazing unit, in connection with the inner interpane space 12 via perforations 7 in the glazing interior wall 3 of the hollow-profile strip 1. All glazing interior walls 3 are provided with perforations 7 and thus implemented as permeable sections 1a. The desiccant 11 can thus absorb moisture out of the inner interpane space 12 and can prevent fogging of the panes. The section of the hollow-profile strip 1 in which the second opening 37 of the capillary tube 33 is arranged is not filled with a desiccant. Since this section is free of desiccant 11, the first opening 37 of the capillary tube is protected against clogging by dust by a molecular sieve. In the finished insulating glazing unit, a connection of the inner interpane space 12 and the hollow spaces 5 is ensured via the perforations 7 in the glazing interior wall 3. The second opening 36 of the capillary tube 33 opens into the atmosphere. The capillary tube 33 thus establishes a connection between the hollow space 5 and the atmosphere and enables pressure equalization between the surroundings and an inner interpane space 12. The capillary tube 33 has a total length of 80 cm. Of that, only approx. 7 cm, corresponding to 9% of the total length, is positioned outside the spacer frame 8. Most of the capillary tube 33 is arranged inside the hollow space 5 of the first section 1.1 of the hollow-profile strip 5. Thus, the capillary tube 33 is optimally protected, both during the installation of the spacer frame 8 in the insulating glazing unit and during the entire service life of the insulating glazing unit.

FIG. 4 depicts a cross-section through a section of an insulating glazing unit according to the invention in the corner region. The corner connector I according to the invention corresponds in its main features to that depicted in FIG. 1 and differs only in the shape of the capillary tube 33 in the corner region 34. The capillary tube 33 is bent in the corner region 34 in an angle of approx. 145° in contrast to an angle of approx. 90° in FIG. 1. The first plug-in leg 31 and the second plug-in leg 32 are, in each case, arranged inside a hollow profile 1 or in a hollow space 5 of the hollow profile. In this example, the capillary tube 33 opens into a section of the hollow-profile strip 1 filled with desiccant 11. The second opening 37 of the capillary tube 33 is situated in the hollow space 5 of the hollow-profile strip 1. The glazing interior wall 3 of the hollow-profile strip 1 is implemented gas-permeable, made, for example, of a porous plastic such that a gas exchange can occur between an inner interpane space and hollow space 5. When a gas-permeable material is used for the hollow-profile strip 1, the outer wall 4 is provided with a barrier film 6 that improves the leak-tightness of the edge seal. A secondary sealant 16 that improves the mechanical stability of the insulating glazing unit is arranged in the outer interpane space 24 adjacent the outer wall 4 and the corner face 38 of the corner connector I. The capillary tube 33 runs through the secondary sealant 16 such that the first opening 36 of the capillary tube 33 is open to the atmosphere. The secondary sealant 16 is, for example, an organic polysulfide.

FIG. 5 depicts a perspective cross-section of a hollow-profile strip 1. The hollow-profile strip 1 comprises two parallel side walls 2.1 and 2.2, which establish the contact with the panes of an insulating glazing unit. The side walls 2.1 and 2.2 are connected via an outer wall 4 and a glazing interior wall 3. The outer wall 4 runs substantially parallel to the glazing interior wall 3. The hollow-profile strip 1 is made of a polymer and is, additionally, glass-fiber-reinforced and contains, for example, styrene acrylonitrile (SAN) and approx. 35 wt.-% glass fiber. The hollow-profile strip 1 has a hollow space 5 and the wall thickness of the polymeric hollow profile 1 is, for example, 1 mm. A barrier film 6, that comprises at least one metal-containing barrier layer and one polymeric layer is mounted on the outer wall 4. The entire hollow-profile strip has thermal conductivity less than 10 W/(m K) and gas permeation less than 0.001 g/(m² h).

FIG. 6 depicts a cross-section of a section of an insulating glazing unit according to the invention along the line A^{I}-A^{II} in FIG. 4 (viewing direction is indicated in FIG. 4). The insulating glazing unit II includes the hollow-profile strip 1 described in FIG. 5. The glass-fiber-reinforced polymeric hollow-profile strip 1 with the barrier film 6 affixed thereon is arranged between a first pane 13 and a second pane 14. The barrier film 6 is arranged on the outer wall 4 and on part of the side walls 2.1 and 2.2. The first pane 13, the second pane 14, and the barrier film 6 delimit the outer interpane space 24 of the insulating glazing unit. The secondary sealant 16, which contains, for example, polysulfide, is arranged in the outer interpane space 24. Together with the secondary sealant 16, the barrier film 6 isolates the inner interpane space 12 and reduces the thermal transfer from the glass-fiber-reinforced polymeric hollow-profile strip 1 into the inner interpane space 12. The barrier film 6 can, for example, be attached on the hollow profile strip 1 with a polyurethane (PUR) hotmelt adhesive. A primary sealant 10 is preferably arranged between the side walls 2.1, 2.2 and the panes 13, 14. This contains, for example, a butyl. The primary sealant 10 overlaps the barrier film 6 in order to prevent possible interfacial diffusion. The first pane 13 and the second pane 14 preferably have the same dimensions and thicknesses. The panes preferably have an optical transparency of >85%. The panes 13,14 preferably contain glass and/or polymers, preferably flat glass, float glass, quartz glass, borosilicate glass, soda lime glass, polymethylmethacrylate, and/or mixtures thereof. In an alternative embodiment, the first pane 13 and/or the second pane 14 can be implemented as a composite glass pane. The insulating glazing unit II according to the invention forms, in this case, a triple or quadruple glazing unit. Inside the hollow-profile strip 1, a desiccant 11, for example, molecular sieve, is arranged inside the hollow chamber 5. This desiccant 11 can be filled into the hollow chamber 5 of the hollow-profile strip 1 before the assembly of the insulating glazing unit. The glazing interior wall 3 includes relatively small perforations 7 or pores, which enable a gas exchange with the inner interpane space 12.

FIG. 7 depicts a cross-section of a spacer frame 8 with a corner connector I according to the invention. The spacer frame 8 comprises a hollow profile 1, which is bent to form a rectangular frame. The two ends of the hollow profile 1 are connected via the corner connector I according to the invention. The first plug-in leg 31 is plugged into a section 1b having an impermeable glazing interior wall of the hollow profile 1, and the second plug-in leg 32 is plugged into a section 1a having a permeable glazing interior wall 3. The hollow-profile strip 1 is filled over the entire length with a desiccant 11. The glazing interior wall 3 is implemented gas-permeable in the region of the section 1a, in other words, perforations 7 are made there such that, in the finished insulating glazing unit, a gas exchange between the inner interpane space 12 and the hollow space 5 of the hollow profile 1 can occur. The corner region 34 of the corner connector I according to the invention is implemented solid, in other words, it separates the sections connected by the corner connector I according to the invention from one another and prevents a gas exchange between these two sections. In the finished insulating glazing unit, the ambient air flows out of the second opening 37 into the hollow space 5 of a gas-impermeable section 1b and is pre-dried there through contact with the desiccant 11. The air cannot enter the inner interpane space via the perforations 7 in the glazing interior wall 3 until it reaches the region of the permeable section 1a. Thus, efficient drying of the ambient air is achieved.

### LIST OF REFERENCE CHARACTERS

I corner connector
II insulating glazing unit
1 hollow-profile strip
1a section having a permeable glazing interior wall/permeable section
1b section having an impermeable glazing interior wall/impermeable section
2.1 first side wall
2.2 second side wall
3 glazing interior wall
4 outer wall
5 hollow space or hollow chamber
6 barrier film
7 perforations in the glazing interior wall
8 spacer frame
10 primary sealant
11 desiccant
12 inner interpane space
13 first pane
14 second pane
16 secondary sealant
21 edge of the first pane
22 edge of the second pane
24 outer interpane space
31 first plug-in leg
32 second plug-in leg
33 capillary
34 corner region
35 end face of a plug-in leg
36 first opening of the capillary
37 second opening of the capillary
38 corner face of the corner region
39 side face of the corner region
L length of a plug-in leg
E length of the corner region
s length to be installed of the capillary tube in a linear shape
b length to be installed of the capillary tube in a curved or spiral shape

1.-15. (canceled)

16. A corner connector, comprising:
a first plug-in leg;
a second plug-in leg;
a corner region; and
a capillary tube with a first opening and a second opening,
wherein
the corner region connects the second plug-in leg to the first plug-in leg,
the first and second plug-in legs form an angle α, where 45°<α≤180°,
the first plug-in leg, the second plug-in leg, and the corner region are injection molded,
the capillary tube is integrally molded into the corner region, and
the corner connector is adapted to connect two hollow-profile strips of an insulating glazing unit, wherein the capillary tube is configured to establish a connection between an inner interpane space and corresponding surroundings of the insulating glazing unit.

17. The corner connector according to claim 16, wherein the capillary tube is bent or wound at least in a subregion to provide a curved or spiral shape, so that a length to be installed, b, of the capillary tube in the curved or spiral shape is shorter than a length to be installed, s, of the capillary tube in a linear shape.

18. The corner connector according to claim 17, wherein b and s are bound by the following relationship:
0.05≤b/s≤0.55.

19. The corner connector according to claim 17, wherein b and s are bound by the following relationship:
0.1≤b/s≤0.35.

20. The corner connector according to claim 16, wherein the capillary tube protrudes from the corner connector on an end face of the first plug-in leg, is arranged inside at least the first plug-in leg, and
protrudes from the corner region of the corner connector.

21. The corner connector according to claim 16, wherein the first plug-in leg and the second plug-in leg form a right angle.

22. The corner connector according to claim 16, wherein a first opening of the capillary tube on an end that protrudes from the corner region is reversibly closed.

23. The corner connector according to claim 22, wherein said first opening is closed by a rubber cap.

24. The corner connector according to claim 16, wherein the capillary tube is made of a metal.

25. The corner connector according to claim 24, wherein the metal comprises stainless steel or aluminum.

26. An insulating glazing unit, comprising:
a first pane;
a second pane;
a spacer frame arranged between the first and second panes, the spacer frame comprising at least one hollow-profile strip and one corner connector; and
an inner interpane space that is delimited by the first pane, the second pane, and the spacer frame,
wherein the corner connector comprises
i) a first plug-in leg,
ii) a second plug-in leg that is connected, in a corner region of the corner connector, to the first plug-in leg, and
iii) a capillary tube integrated in the corner region,
wherein the first plug-in leg, the second plug-in leg, and the corner region are injection molded,
wherein the first plug-in leg and the second plug-in leg are each plugged into a respective end of the at least one hollow-profile strip, and
wherein the capillary tube establishes a connection between the inner interpane space and surrounding atmosphere.

27. The insulating glazing unit according to claim 26, wherein the hollow-profile strip comprises:
a first side wall;
a second side wall arranged parallel to the first side wall;
a glazing interior wall arranged perpendicular to the first and second side walls, the glazing interior wall connecting the first side wall to the second side wall;
an outer wall arranged substantially parallel to the glazing interior wall, the outer wall connecting the first side wall to the second sidewall; and
a hollow space that is surrounded by the first and second side walls, the glazing interior wall, and the outer wall,
wherein the glazing interior wall contains at least one permeable section, and
wherein the hollow space contains a desiccant at least in the permeable section.

28. The insulating glazing unit according to claim 27, wherein 40% to 0.5% of a length of the capillary tube is arranged outside the spacer frame.

29. The insulating glazing unit according to claim 27, wherein 15% to 1% of a length of the capillary tube is arranged outside the spacer frame.

30. The insulating glazing unit according to claim 27, wherein the capillary tube has a first opening that is open to the atmosphere,
has a second opening that is arranged in the hollow space of the hollow-profile strip, and
is arranged at least inside the first plug-in leg and in the corner region.

31. The insulating glazing unit according to claim 30,
wherein the second opening of the capillary tube is arranged in an impermeable section of the hollow-profile strip having an impermeable glazing interior wall, and
wherein the impermeable section is connected to a permeable section.

32. A method for producing an insulating glazing unit, the method comprising:
preparing a hollow-profile strip;
connecting the hollow-profile strip to form a complete spacer frame using at least one corner connector;
filling the hollow-profile strip with a desiccant;
installing a first pane and a second pane on the spacer frame via a primary sealant, thereby creating an inner interpane space and an outer interpane space; and
installing a secondary sealant in the outer interpane space,
wherein the at least one corner connector comprises
a first plug-in leg,
a second plug-in leg,
a corner region, and
a capillary tube with a first opening and a second opening,
wherein
the corner region connects the second plug-in leg to the first plug-in leg,
the first and second plug-in legs form an angle α, where 45°<α≤180°,
the first plug-in leg, the second plug-in leg, and the corner region are injection molded, and
the capillary tube is integrally molded into the corner region.

33. A method, comprising:
providing an insulating glazing unit according to claim 26; and
using of the insulating glazing unit as a building interior glazing unit, a building exterior glazing unit, or a facade glazing unit.
